(19) United States
(12) Patent Application Publication
(10) Pub. No.: US 2015/0278358 A1
(43) Pub. Date: Oct. 1, 2015

(54) ADJUSTING SERP PRESENTATION BASED ON QUERY INTENT

(71) Applicant: Microsoft Corporation, Redmond, WA (US)

(72) Inventors: Elbio Renato Abib, Bellevue, WA (US); Ashish Gandhe, Seattle, WA (US); Gaurav S. Anand, Seattle, WA (US); Anderson Aiziro, Bellevue, WA (US); Rylan Michael Hawkins, Seattle, WA (US); Hossein Shahbazi, Seattle, WA (US)

(73) Assignee: Microsoft Corporation, Redmond, WA (US)

(21) Appl. No.: 14/242,608

(22) Filed: Apr. 1, 2014

(51) Int. Cl. G06F 17/30; G06N 99/00

(52) U.S. Cl. CPC G06F 17/30864; G06N 99/005

(57) ABSTRACT

Systems, methods, and computer-readable storage media are provided for adjusting presentation characteristics of a search engine results page (SERP) by a client device based on a query intent of a user. The client may forward a search prefix to a search service and in response receive one or more query suggestions and one or more machine learning algorithms configured to each query suggestion. The user executes a search query comprising the query intent by selecting one of the query suggestions. The client device computes scores for each result group using the machine learning algorithm configured for the selected query suggestion. At least one presentation characteristic of the SERP is adjusted so that at least one result group is emphasized over another based on the respective result group scores representing a relevance to the query intent.

### BACKGROUND

Users often employ a variety of search components to locate desired content for use on a computing device. Functional limitations of some search utilities may compel users to resort to different search components depending on the domain in which the desired content may be stored. For example, a user may employ a local search component of the computing device's operating system to locate content stored locally on the computing device (“local domain”). The user may then access a remote search component via a web browser to locate content stored external to the computing device (“web domain”). The remote search component may return search results for the web domain identifying content such as web pages, internet-based multimedia content, or various files stored on a remote server. Exemplary remote search engines are well known in the art, for instance, a commonly known commercial engine is the BING™ search engine provided by Microsoft Corporation of Redmond, Wash. Furthermore, search results within a domain (i.e. the local domain and/or the web domain) may be classified by a result group according to a type of content. For example, local domain search results may be classified into a document, multimedia, application, and/or setting result group.

Some search components may communicate a user's search query to both a local search component and a remote search component. These global search components may allow the user to simultaneously locate content in both a local and web domain that may be relevant to the user's search query. One such example is the SMART SEARCH™ search component in the WINDOWS 8.1™ operating system provided by Microsoft Corporation of Redmond, Wash. A global search component may receive search results from both the local search component and the remote search component. These search results may be ranked based on relevance to the user's search query within one or more result groups of each respective domain. The global search component may simultaneously present ranked result groups from both the local and web domain search results to the user through a single search engine results page (“SERP”). Thus, users of global search components may locate both locally and remotely stored content by submitting a single search query.

The ability to receive search results regarding content from a wider range of sources provided by global search components may simultaneously be a benefit and a hindrance. On the one hand, the user gains the benefit of receiving a much larger volume of relevant search results in response to a single search query. Yet, the user must now sift through a larger volume of potentially relevant search results drawn from a larger pool of sources to locate their desired content. Depending on the context of a search query, search results from some sources may match a user's query intent more than others. Thus, local domain search results may match the user's query intent more than remotely stored content, or vice versa. Also, within a domain one result group may match the user's query intent more than another.

For example, search results from the web domain may match the user's query intent more than those from the local domain for a search query of “actor John Doe news.” Alternatively, search results from the local domain may match the user's query intent more than those from the web domain for a search query of “*.doc”. Furthermore, search results from a document result group within the local domain may match the user's query intent more than those from a settings result group based on that search query. In some instances, both local and web domain search results may equally match the user's query intent, for example, for a search query of “singer Jane Doe music.” The user could equally intend to locate a copy of a Jane Doe song in the local domain as a webpage in the web domain detailing Jane Doe's upcoming album. However, a search result from a music result group within the local domain may match the user's query intent more than those from a documents result group.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for, among other things, adjusting one or more presentation characteristics of a Search Engine Result Page (“SERP”) to emphasize at least one result group to the user that matches a user's query intent more than another. The presentation characteristic adjustments are based, at least in part, on a result group score computed locally on a client device. The result group scores are computed using one or more Machine Learning Algorithms (“MLAs”) received from a remote search service via a network.

### BRIEF DESCRIPTION OF THE DRAWINGS

Embodiments of the invention are illustrated by way of example and not limited in the accompanying figures in which like reference numerals indicate similar elements and in which:

FIG. 1 is a block diagram of an exemplary computing environment suitable for use in implementing embodiments of the invention;

FIG. 2 is a block diagram of an exemplary computing system suitable for use in implementing embodiments of the invention;

FIG. 3 is a logic diagram for a method of adjusting presentation characteristics based on a user's query intent, in accordance with an embodiment of the present invention;

FIG. 4 is a logic diagram for a method of providing machine learning algorithms for use by a client device to compute result group scores on client-computed result group scores, in accordance with an embodiment of the present invention;

FIG. 5 is a screen shot showing an exemplary search display area configured to accept a search query from a user, in accordance with an embodiment of the present invention;

FIG. 6 is a screen shot showing an exemplary SERP display before adjusting presentation characteristics based on a user's query intent, in accordance with an embodiment of the present invention;

FIG. 7 is a screen shot similar to FIG. 6 showing an exemplary SERP display area after adjusting result group order based on a user's query intent, in accordance with an embodiment of the present invention;

FIG. 8 is a screen shot similar to FIG. 6 showing an exemplary SERP display after adjusting domain order based on a user's query intent, in accordance with an embodiment of the present invention;

FIG. 9 is a screen shot similar to FIG. 6 showing an exemplary SERP display after adjusting result group sizing based on a user's query intent, in accordance with an embodiment of the present invention;

FIG. 10 is a screen shot similar to FIG. 6 showing an exemplary SERP display after adjusting result domain sizing based on a user's query intent, in accordance with an embodiment of the present invention; and

FIG. 11 is a screen shot similar to FIG. 6 showing an exemplary SERP display after adjusting result group order and sizing based on a user's query intent, in accordance with an embodiment of the present invention.

### DETAILED DESCRIPTION

The subject matter of this patent is described with specificity herein to meet statutory requirements. However, the description itself is not intended to necessarily limit the scope of the claims. Rather, the claimed subject matter might be embodied in other ways to include different steps or combinations of steps similar to the ones described in this document, in conjunction with other present or future technologies. Although the terms “step,” “block,” or “component,” etc., might be used herein to connote different components of methods or systems employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, providing query-completion suggestions configured to be searched against information domains. Information domains are content sites generally provided in association with a search engine (local or remote) that provides content and organization specific to a particular topic. Embodiments hereof further are directed to providing MLAs specific to query-completion suggestions and to adjusting one or more presentation characteristics of a SERP to emphasize at least one result group to the user that matches a user's query intent more than another. The presentation characteristic adjustments are based, at least in part, on a result group score computed locally on a client device utilizing MLAs received from a remote search service via a network.

Accordingly, some embodiments of the invention are directed to one or more computer-readable media having computer-executable instructions thereon that when executed by a computing device perform a method of adjusting presentation characteristics of a search engine results page (SERP) based on a query intent of a user. The method includes transmitting a search prefix comprising at least one character associated with an unexecuted search query to a search service, receiving one or more query suggestions and a machine learning algorithm configured to each query suggestion in response to the search prefix, transmitting an executed search query selected by the user from the query suggestions based in part on the query intent to a local search component configured to locate content stored in a local domain, receiving a plurality of result groups comprising at least one search result identifying content in the local domain from the local search component, and computing a result group score for each of the plurality of result groups using the machine learning algorithm configured to the selected query suggestion, wherein each result group score defines a relevance of the result group to the query intent, and wherein each result group score is based in part on client-computed features.

Another embodiment of the invention is directed to a system comprising one or more computer-readable media having computer-executable instructions thereon that when executed by a computing device perform a method of adjusting presentation characteristics of a SERP based on a query intent of a user. The method includes receiving a search prefix from a client device comprising at least one character associated with an unexecuted search query and transmitting one or more query suggestions and one or more machine learning algorithms configured to each query suggestion in response to the search prefix. Each machine learning algorithm is configured to compute a result group score defining a relevance of the result group to the query intent upon execution thereof, the execution being triggered upon receipt of a user-selection of the respective query suggestion.

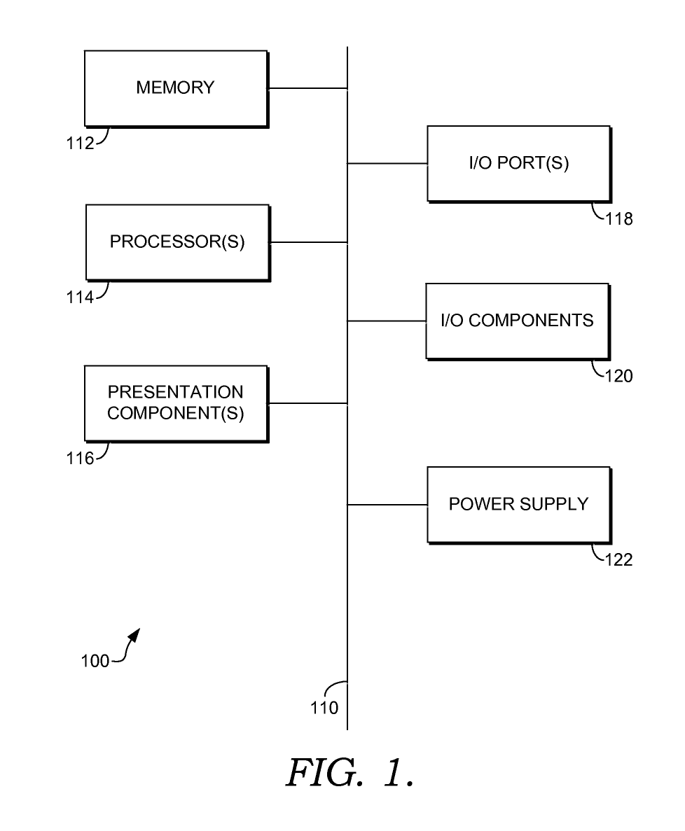

Having briefly described an overview of embodiments of the invention, an exemplary operating environment in which embodiments of the invention may be implemented is described below to provide a general context for various aspects of these embodiments. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

The embodiments of the invention may be described in the general context of computer code or machine-useable instructions, including computer-executable instructions such as program components being executed by a computer or other machine, such as a personal data assistant or other handheld device. Generally, program components including routines, programs, applications objects, components, data structures, and the like, refer to code that performs particular tasks or implements particular abstract data types. Embodiments of the invention may be practiced in a variety of system configurations, including handheld devices, tablet computers, consumer electronics, general-purpose computers, specialty computing devices, etc. Embodiments of the invention may also be practiced in distributed computing environments where tasks are performed by remote-processing devices that are linked through a communications network.

As utilized herein, the phrase “computing device” generally refers to a dedicated computing device with processing power and storage memory, which supports operating software that underlies the execution of software, applications, and computer programs thereon. As one skilled in the art will appreciate, computing device 100 may include hardware, firmware, software, or a combination of hardware and software. The hardware includes processors and memories configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs).

The hardware logic allows a device to adjust one or more presentation characteristics of a SERP display to emphasize at least one result group that matches a user's query intent more than another to the user. The device may receive ranked search results within a plurality of result groups in response to a search query from a local search component and/or a remote search component. The local search component may send result groups from a local domain and the remote search component may send at least one result group from a web domain. The device may be configured to locally compute one or more result group scores based on machine learned algorithms (“MLAs”) received from a search service via a network. The device may determine which result group and/or domain matches a user's query intent more than another based on the computed result group scores. The device may adjust one or more presentation characteristics of a SERP display to emphasize at least one result group that matches the user's query intent more than another, and present the SERP display to the user. Query intent, as used herein, refers to a relevance of a result group and/or domain to a user search query based in part on the relevance of search results within the result group.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component, such as a display device, to be an I/O component. Also, processors have memory. The inventors hereof recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

The computing device 100 typically includes a variety of computer-readable media. Computer-readable media can be any available media that is accessible by the computing device 100 and includes both volatile and nonvolatile media, removable and non-removable media. Computer-readable media may comprise computer storage media and communication media; computer storage media excluding signals per se.

Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired data and that can be accessed by the computing device 100. In an embodiment, the computer storage media can be selected from tangible computer storage media like flash memory. These memory technologies can store data momentarily, temporarily, or permanently. Computer storage does not include and excludes communication media.

On the other hand, communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as the memory 112 or the I/O components 120. The presentation component(s) 116 present data indications to a user or other device. Exemplary presentation components 116 include a display device, speaker, printing component, vibrating component, etc. The I/O ports 118 allow the computing device 100 to be logically coupled to other devices including I/O components 120, some of which may be built in. Illustrative I/O components include a microphone, joystick, game pad, satellite dish, scanner, printer, wireless device, a controller (such as a stylus, keyboard, and mouse) or a natural user interface (NUI), etc.

A NUI processes gestures (e.g., hand, face, body, etc.), voice, or other physiological inputs generated by a user. These inputs may be interpreted as queries, requests for selecting URLs, or requests for interacting with a URL included as a search result. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

As previously mentioned, embodiments of the invention are generally directed to systems, methods, and computer-readable storage media for, among other things, adjusting one or more presentation characteristics of a SERP to emphasize at least one result group that matches a user's query intent more than another to the user. The presentation characteristic adjustments are based in part on a result group score computed locally on a client device. The result group scores are computed using one or more MLAs received remotely from a search service via a network.

Various aspects of the technology described herein are generally employed in computer systems, computer-implemented methods, and computer-readable storage media for, among other things, providing MLAs associated with query completion suggestions in response to a received search prefix for use by a client device to compute one or more result group scores. In one embodiment, a server executes a query formulation component that sends one or more query completion suggestions in response to a received search prefix. The query formulation component may also provide one or more MLAs for each query completion suggestion sent. The server may also execute a remote search component that receives a search query selected from the one or more query completion suggestions sent and in response provide one or more search results from a web domain. The server may also execute a query log component that may receive feedback information based on a user's interaction with search results from the web domain and a local domain associated with the user's computing device that may be used to train MLAs.

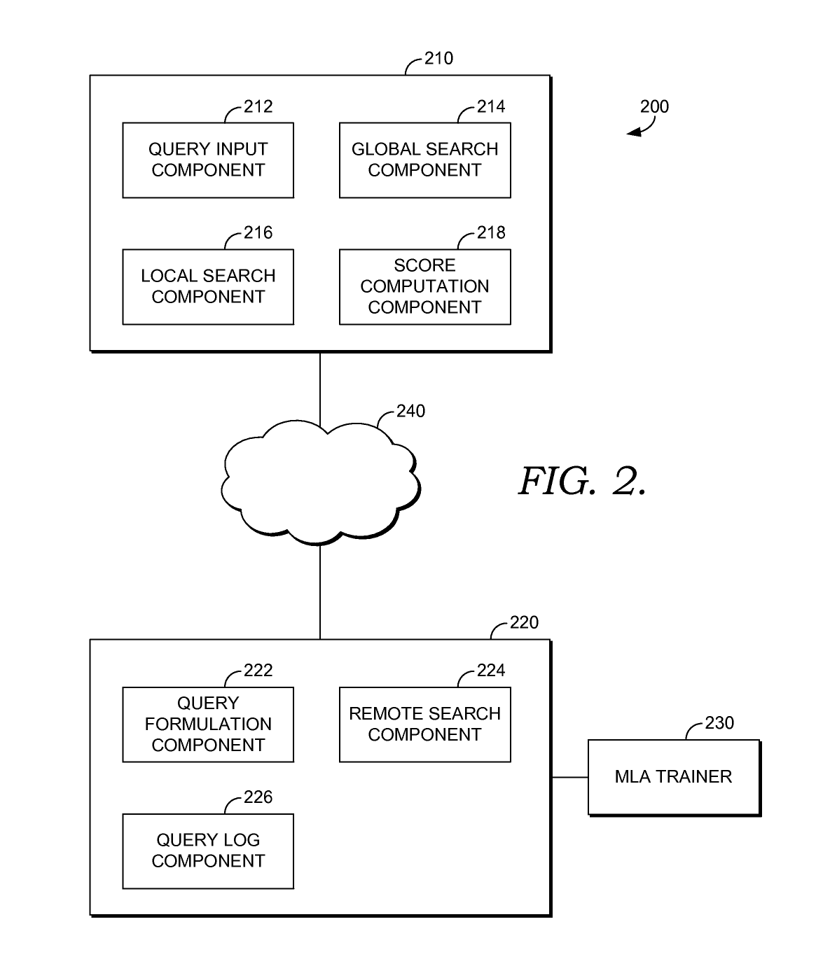

Referring now to FIG. 2, a block diagram is provided illustrating an exemplary computing system 200 in which embodiments of the invention may be employed. Generally, the computing system 200 is configured to adjust one or more presentation characteristics of a SERP to emphasize to the user at least one result group that matches a user's query intent more than another. The computing system 200 includes, among other components, a query input component 212, a global search component 214, a local search component 216, and a score computation component 218. As more fully described below, the query input component 212 communicates with a search service 220 to provide a user one or more query completion suggestions based on a received search prefix. The global search component 214 receives a search query that is forwarded to a local search component and/or a remote search component. The local search component 216 sends local domain search results to the global search component 214 in response to the search query that identifies local content relevant to the search query. The score computation component 218 receives one or more MLAs from a search service associated with at least one query completion suggestion, and calculates a result group score for each result group of the search results.

As illustrated, the computing system 200 includes a client device 210, a search service 220, a machine learning algorithm (“MLA”) trainer 230, and a network 240. The network 240 may communicatively connect the client device 210 and the search service 220. It should be understood that any number of client computing devices (e.g. client device 210) and search services (e.g. search service 220) may be employed in the computing system 200 within the scope of embodiments of the invention. Each may comprise a single device/interface or multiple devices/interfaces cooperating in a distributed environment. For instance, the search service 220 may comprise multiple devices and/or modules arranged in a distributed environment that collectively provide the functionality of the search service 220 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the client device 210, as an Internet-based service, or as a module inside the search service 220. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines or client computing devices. By way of example only, search service 230 may be provided as a single server (as shown), a cluster of servers, or a computing device remote from one or more of the remaining components.

The client device 210 may communicate with the search service 220 to facilitate a user's search for content. For example, a user may utilize the client device 210 to simultaneously search for content available both in a local memory (e.g. memory 112 of FIG. 1) of the client device 210 and via the network 240. Content available in the local memory of the client device 210 may be referred to herein as local domain content. In some embodiments, local domain content may refer to content stored by the user on a device external to the client device 210 (e.g. an external hard drive, cloud storage, external flash memory, and the like). Content available via the network 240 may be referred to herein as web domain content. In some embodiments, the network 240 might be the Internet, and the client device 210 interacts with the search service 220 to search for web domain content stored on servers associated with websites. In other embodiments, the network 240 might be an enterprise network associated with a company. In these embodiments, the client device 210 may interact with the search service 220 to search for web domain content stored on various nodes within the enterprise network. It should be apparent to those having skill in the relevant arts that any number of other implementation scenarios may be possible as well.

The client device 210 may be a computing device (e.g. computing device 100 of FIG. 1) configured to adjust a SERP presentation in order to emphasize at least one result group that matches a user's query intent more than another to the user. The client device 210 includes the following components, any of which may be implemented, alone or in combination, to adjust the SERP presentation: a query input component 212, a global search component 214, a local search component 216, and a score computation component 218.

The query input component 212 may be configured to receive a search prefix from a user searching for content via an input device in communication with the client device 210. For example, the input device may include a mouse, joystick, key pad, microphone, I/O components 120 of FIG. 1, or any other component capable of receiving a user input and communicating an indication of that input to the client device 210. A search prefix, as used herein, refers to one or more characters associated with an unexecuted search query from a user attempting to locate a content item. The query input component 212 may communicate with the search service 220 to provide the user with one or more query completion suggestions. A query completion suggestion, as used herein, refers to a potential completion to the search prefix in part based on such things as a dictionary of complete words/phrases and/or logged queries received by the search service 220 from previous users. As such, query formulation suggestions refer to information (e.g., entities, categories, attributes, attribute values, and the like) that may be used to ascertain a user's true intent upon inputting a search query, or portion thereof. Query completion suggestions may be updated with one or more updated potential completions as the user modifies the search prefix. Query input component the potential completions in an area proximate to where the user is inputting the initial characters.

The global search component 214 may be configured to receive a search query via query the input component 212. In response to receiving the search query, the global search component 214 may forward the search query to the local search component 216 and/or the search service 220. The global search component 214 may be further configured to receive search results from the local search component 216 and/or the search service 220 in response to the forwarded search query. The search results may be presented to the user on a SERP display via a presentation component (not shown). In certain embodiments, the search results may include a content preview (not shown) that allows the user to quickly preview content associated with the search results. In an embodiment, the global search component 214 may be further configured to transmit feedback information to the search service 220 based on user interaction with the local and/or web domain search results. The feedback information may enable the search service 220 to improve future query completion suggestions, search responses, and/or MLAs. In this embodiment, feedback information transmitted to the search service 220 may not include information specific to the user.

Search results, as used herein, refer to content and/or links to content that are determined to satisfy (or at least substantially satisfy) a search query. Often, presented search results are approximations of satisfying results rather than exact result matches, such as when an insufficient number of satisfying search results is available. Those of skill in the art will understand that search results differ from query completion suggestions not only in content (although in some instances the content may be substantially similar), but also in their use upon user selection thereof.

In some embodiments, the user may instruct the global search component 214 to forward the search query to a specific domain or both domains via the search input display. In these embodiments, an input may be presented to the user via search input display enabling the user to limit a search to a specific domain (e.g. only the local or web domain) or both domains. For example, if the user limits the search to the web domain via the input, the global search component 214 may only forward the search query to the search service 220.

The local search component 216 may be configured to receive a search query from the global search component 214 and return search results to the global search component 214 identifying content in the local domain relevant to the search query. The local search component 216 may operate as a conventional search engine by indexing content from the local domain and returning ranked search results in response to search queries. In some embodiments, the local search component 216 may be further configured to record user clicks on search results to improve searching.

The score computation component 218 may be configured to receive one or more MLAs from the search service 220. MLAs may provide a plurality of factors for the score computation component 218 to use in calculating a score for each domain and/or result group. The domain and/or result group score may be used to determine how closely the domain or result group matches a user's query intent relative to another. These factors may include one or more weighting values to be applied to one or more client-computed features for each domain and/or result group. The factors may also include one or more threshold values that may apply to each domain and/or result group when determining their relative degree of user query intent match. Another factor may include a constant value that may be used to equalize weighted client-computed features. In an embodiment, the constant value may provide a direct score in which case weighting values may be ignored. Result groups, as used herein, refer to a categorization or grouping of results based on a commonality. For example, results within a local domain may be categorized into result groups such as applications, settings, data files, and the like. Data files may be further categorized into result groups such as documents, multimedia content (e.g. music, videos, etc.), compressed archive files, and the like.

Client-computed features may be a set of values for each result group and/or domain determined by the score computation component 218 based on characteristics of the results within each respective result group and/or how the results match the search query. A result group score for every result group may be computed by score computation component 218 based on a combination of client-computed features and MLAs. Client-computed features may be available to the score computation component 218 via computer readable-media (e.g. the computer readable-media discussed with regards to FIG. 1). Alternatively, in some embodiments, client-computed features may be accessed by the client device 210 via the network 240.

For example, client-computed features may include a number of results within a result group, ranks for results within the result group computed by the local search component 216, and/or a type of match for results in the result group. The type of match for results may include elements such as result title and/or keyword matches with the search query. Also, the type of match for results may be partially based on the result group of the result. For example, a result within a music result group may have client-computed features such as artist, genre, and/or album title matches with the search query.

The client device 210 may use the result group scores to adjust various presentation characteristics of a SERP display presented in response to the search query as described herein. Generally, the client device 210 may be in communication with a presentation component (e.g. the presentation component discussed with regards to FIG. 1). The presentation component is configured to present various content including, without limitation, search input displays and SERP displays as described herein. In embodiments, the display may be further configured to enable touch inputs from a user or provide a NUI. The presentation component, which may be operably coupled to an output of the client device 210, may be configured as any presentation component that is capable of presenting information to a user, such as a digital monitor, electronic display panel, touch-screen, analog set-top box, plasma screen, audio speakers, Braille pad, and the like. In another exemplary embodiment, the presentation device is capable of rendering other forms of media (e.g., audio signals).

The search service 220 may communicate with the client device 210 to facilitate a user's search for content and dynamic adjustment of a SERP display by the client device. The search service 220 may implement any combination of the following components to perform these functions: a query formulation component 222, a remote search component 224, and a query log component 226.

The query formulation component 222 may be configured to communicate with a query input component (e.g. query input component 212) to provide the user with one or more query completion suggestions. One or more MLAs associated with each query completion suggestion may be forwarded to a score computation component (e.g. score computation component 218) to facilitate a score calculation for both local and web domain result groups. If updated query completion suggestions are provided, the query formulation component 222 forwards one or more MLAs associated with any updated query completion suggestions. As more fully described below, the score calculated by the client device may be used to adjust one or more presentation characteristics of a SERP display to emphasize at least one result group over another.

The remote search component 224 may be configured to receive a search query from the global search component 214 and return ranked search results to the global search component 214 identifying content in the web domain relevant to the search query. The remote search component 224 may operate as a conventional search engine by crawling content from the web domain, indexing web domain content, and returning search results in response to search queries.

The query log component 226 may be configured to receive feedback information from a client device (e.g. client device 210). The feedback information received may comprise information describing user interaction with local and/or web domain search results. For example the feedback information may include elements such as file names or any other information specific to the user that may not be transmitted to the query log component 226. Application specific information may be transmitted to the query log component 226 comprising no information specific to the user for use in improving future query completion suggestions and/or search results. As such, the search service 220 may facilitate the client device 210 with a ranking of local domain result groups while receiving feedback information on user interactions with the search results. The search service 220 may do this without receiving any privacy-sensitive information regarding local domain content. Relegating any privacy-sensitive information to the client device may have functional implications as well (e.g. security issues, performance concerns, and offline access to a global search component). For example, a binding may occur so that a partial set of search results may be presented to the user by the client device 210 in a progressive manner. Therefore, in some embodiments, the local domain results may arrive before web domain results, and accordingly be displayed first. As such, the user may still view result groups without delay in situations where other result groups or web domain results have not yet been received and some partial result group score computation is possible

The query log component 226 may store user's feedback information and/or aggregate feedback information from a plurality of users. The search service 220 may utilize the user's and/or aggregate feedback information to improve future query completion suggestions and/or search results. For example, the search service 220 may use feedback information to provide improved query completion suggestions and/or search results tailored for the user. The search service 220 may also use feedback information for general improvements to query completion suggestions and/or search results for any future user. The query log component 226 may be further configured to forward the user's and/or aggregate feedback information to the MLA trainer 230.

The MLA trainer 230 may be configured to receive a user's and/or an aggregation of a plurality of users' feedback information from the query log component 226. The feedback information may be used by MLA trainer to train MLA factors offline (e.g. weighting, threshold, and constant values). As such an MLA may be updateable and configurable for each user search query received. The MLA trainer 230 may be further configured to implement a late-binding MLA evaluation in order to prevent the disclosure of private, secure, or any local domain specific information to the search service 220.

The network 240 may be configured to communicatively couple the client device 210 and the search service 220. The network 240 may include any number of networks such as, for example, a local area network (LAN), a wide area network (WAN), the Internet, a cellular network, a peer-to-peer (P2P) network, a mobile network, or a combination of networks. Such networking environments are commonplace in offices, enterprise-wide computer networks, intranets and the Internet. Accordingly, the network 214 is not further described herein. Such networking environments are commonplace in offices, enterprise-wide computer networks, intranets and the Internet. Accordingly, the network 214 is not further described herein.

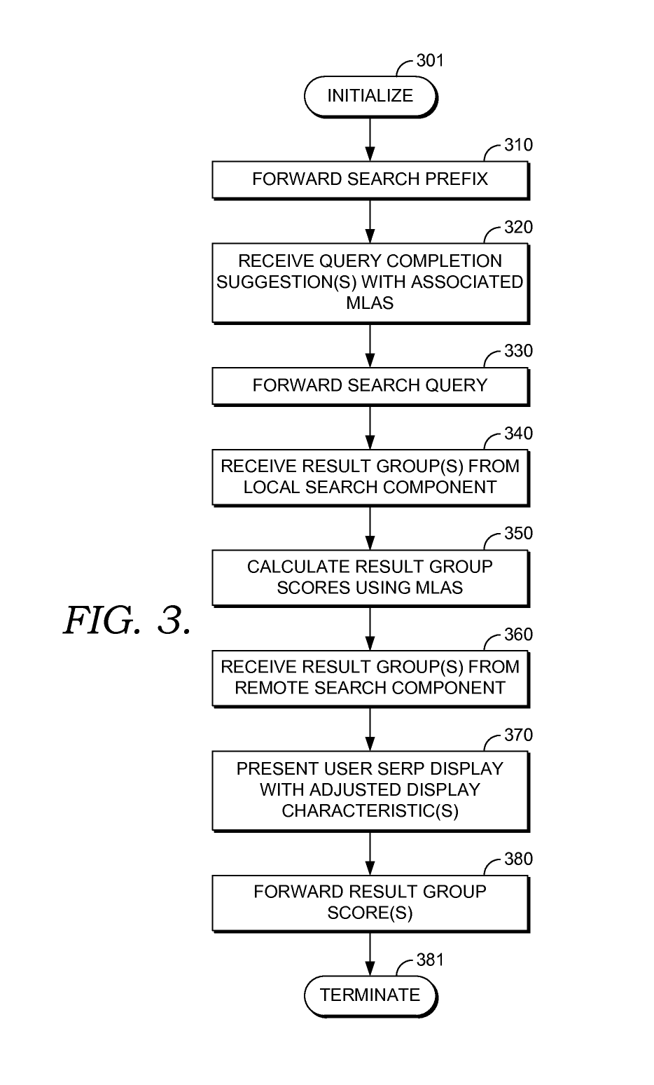

Turning now to FIG. 3, a logic diagram for a method of adjusting SERP presentation characteristics based on a user's query intent is illustrated, in accordance with an embodiment of the present invention. The method initializes in step 301. A client device, in step 310, may forward a search prefix received from a user to a search service. The search prefix may comprise one or more characters associated with an unexecuted search query representing a search by the user for desired content.

In step 320, the search service may return, in response to the search prefix, one or more query completion suggestions and one or more MLAs associated with each query completion suggestion. An MLA may comprise a plurality of factors for the client device to use in calculating a score for each domain and/or result group. The score may determine how each domain and/or result group matches a user's query intent relative to others. In step 330, the client device may forward a search query representing the query completion suggestion selected by the user to execute the search for desired content. The search query may be forwarded to a local search component associated with the client device and/or a remote search component associated with the search service.

In step 340, the client device may receive one or more result groups that each comprises at least one search response from the local search component, in response, identifying local content relevant to the search query. In step 350, the client device may calculate result group scores for each result group in the local and/or web domain based on a combination of client-computed features and MLAs. Client-computed features may be a set of values for each result group and/or domain determined by the client device. Client-computed features may be based on characteristics of the results within each respective result group and/or how the results match the search query.

In step 360, the client device may receive one or more result groups that each comprises at least one search response from the remote search component identifying web content relevant to the search query. In step 370, the client device may present result groups via a SERP display after adjusting one or more presentation characteristics of the SERP display using the computed result group scores. For example, the client device may reorder and/or resize local/web domain result groups to emphasize at least one result group over another based on how closely match they the user's query intent. In step 380, the client device may forward the computed result group scores and/or other feedback information to the search service for logging. The method terminates in step 381.

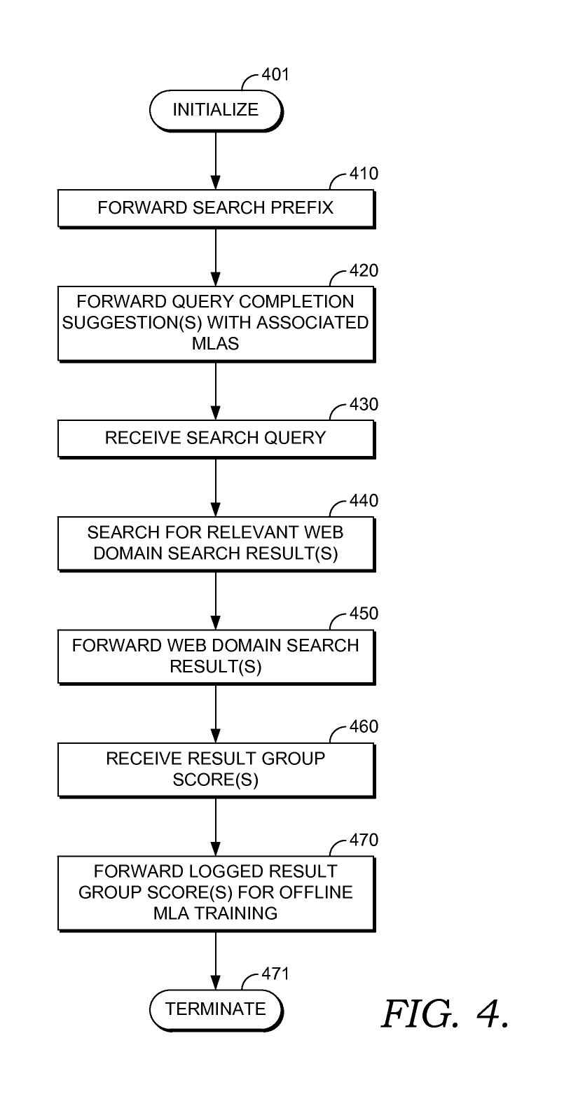

FIG. 4 is an embodiment of a logic diagram for a method of providing MLAs for use by a client device to compute result group scores on client-computed result group scores. The method initializes in step 401. A search service, in step 410, may receive a search prefix input into a client device by a user searching for content. In step 420, the search service may respond by sending one or more query completion suggestions and one or more MLAs associated with each query completion suggestion. In embodiments, the search service may receive an updated search prefix and respond by sending one or more updated query suggestion completions with one or more MLAs associated with an updated query suggestion completion. In step 430, the search service may receive a search query selected by the user from a query completion suggestion sent in step 420. In step 440, the search service may implement a remote search component to generate one or more search responses identifying content in the web domain that are relevant to the search query. In step 450, the search service may forward one or more result groups that each comprises at least one search response identifying web domain content to the client device. In step 460, the search service may receive client-computed result group scores based on at least one MLA sent in step 420 and/or other feedback information to the search service for logging. In step 470, the search service may forward the client-computed result group scores and other feedback information from previous search queries to an MLA trainer for use in training MLA factors offline (e.g. weighting, threshold, and constant values). The method terminates in step 471.

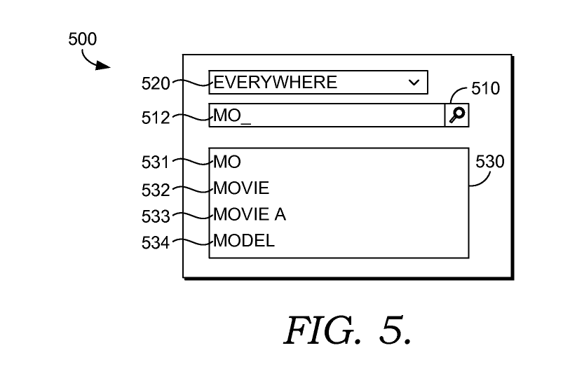

FIG. 5 is an embodiment of a screen shot showing an exemplary search input display 500 configured to accept a search query from a user. In an embodiment, search input display 500 may be presented on any type of UI associated with a computing device, such as the presentation component described with reference to FIG. 2. During entry of the search query, search bar 510 may display a search prefix 512 that corresponds to the received portion of the search query. Search prefix 512 comprises one or more characters associated with an unexecuted search query. Search prefix 512 may be forwarded to a query formulation component (e.g. query formulation component 232 of FIG. 2). In response, the query formulation component may return one or more query-completion suggestions determined as most relevant to search prefix 512. The returned query-completion suggestions may be displayed to the user via autosuggest display area 530. If one of the query-completion suggestions matches the user's intent, the user may execute a search by selecting the appropriate query-completion suggestion to submit the search query. Alternatively, the user may continue entry of the search query that may update search prefix 512. The query formulation component may update one or more query completion suggestions as updates to search prefix 512 occur. The query-completion suggestions may be updated continuously until one of the query-completion suggestions matches the user's query intent and the search query is submitted. Several different types of interface elements are contemplated with embodiments of the present invention. In the case of search input display 500, search query elements may be inferred using a number of different factors. It should be noted, however, that embodiments of the present invention are not limited to users inputting a search query into a traditional query-input region of a screen display.

In an embodiment, search display area 500 may further comprise query scope input 520 that enables the user to define a scope of the query. For example, query scope input 520 may be a drop down menu comprising options such as “Everywhere”, “Local Only”, and/or “Remote Only”. A global search component (e.g. global search component 214 of FIG. 2) may limit a search to content stored locally in the client domain only in response to an input of “Local Only” received via query scope input 520. Conversely, the global search component may limit a search to content stored remotely in the web domain only in response to an input of “Remote Only” received via query scope input 520. Alternatively, the global search component may search content stored in both the client and web domains in response to an input of “Everywhere” received via query scope input 520.

For example, the user may be searching for content associated with “Movie A” and begins entering the search query “Movie A” in the search bar. After the user enters the first two characters of the search query, a search prefix 512 (“mo”) may be forwarded to the query formulation component. Autosuggest display area 530 may update accordingly to display one or more query completion suggestions (e.g. “mo” 531, “movie” 532, “Movie A” 533, and/or “model” 534.) As “Movie A” 533 matches the user's query intent in this example, the user may execute a search query by selecting query completion suggest “Movie A” 533 via an input device.

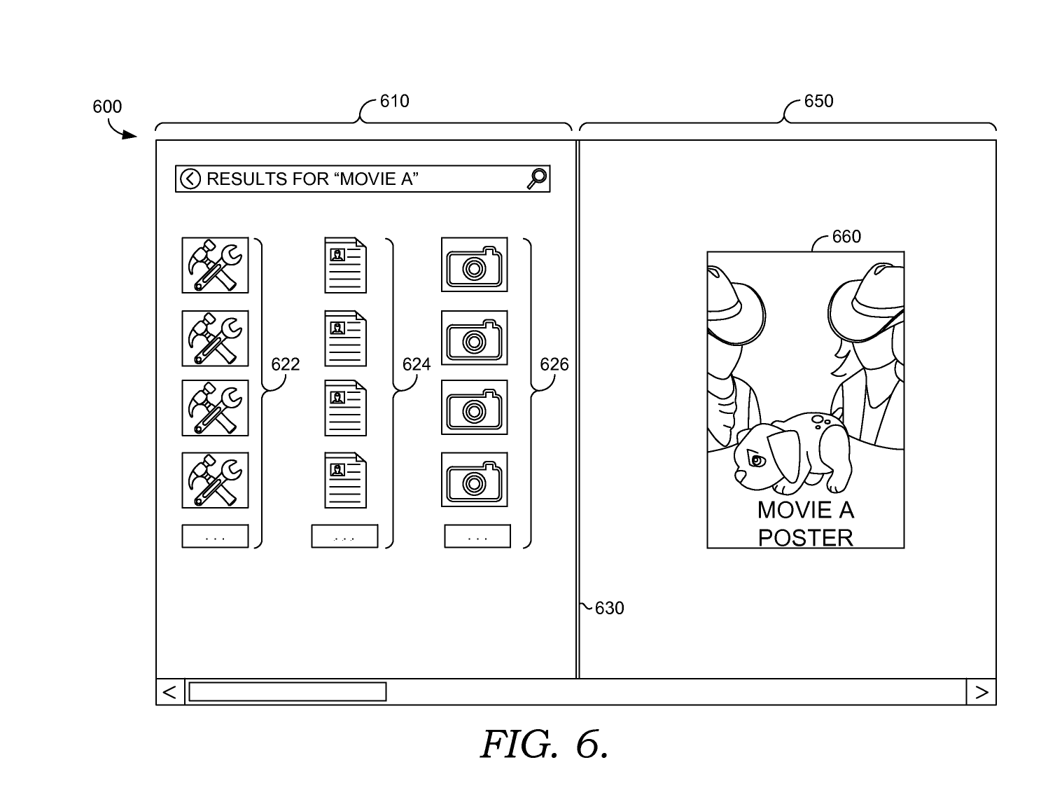

FIG. 6 is an embodiment of a screen shot showing an exemplary SERP display 600 before adjusting presentation characteristics based on a user's query intent. As discussed above, a client device (e.g. client device 210 of FIG. 2) may receive search results received in response to a search query, and present those search responses in the form of a SERP display. In an embodiment, SERP display 600 may be presented on any type of display associated with a computing device, such as presentation device described with reference to FIG. 2. A conventional search component may return SERP display 600 to the user executing the “Movie A” search query in the FIG. 5 example. As shown by FIG. 6, local domain result groups (e.g. result groups 622, 624, and 626) and web domain result groups (e.g. web result group 660) may be displayed in a static order using static presentation characteristics.

In the embodiment of FIG. 6, SERP display 600 may use a preconfigured local domain display area 610 of a uniform size to layout client domain result groups in a uniform configuration. For example, setting result group 622 may consistently be placed in a column of a uniform number of search results on the far left side of client domain display area 610. Likewise, documents result group 624 and photo result group 626 may always follow setting result group 622, in a middle column and right column in the client domain display area 610 respectively, with a uniform number of search results. Also, the user in this example may always expect to find web result groups (e.g. result group 660) in a web domain display area 650 adjacent to client domain display area 610. Similar to client domain display area 610, web domain display area 650 may be preconfigured to uniform sized web result groups in a uniform layout. Therefore, the user would always look to a web domain display area 650 to the right of a display area demarcation line 630 to see if their desired content was found in the web domain.

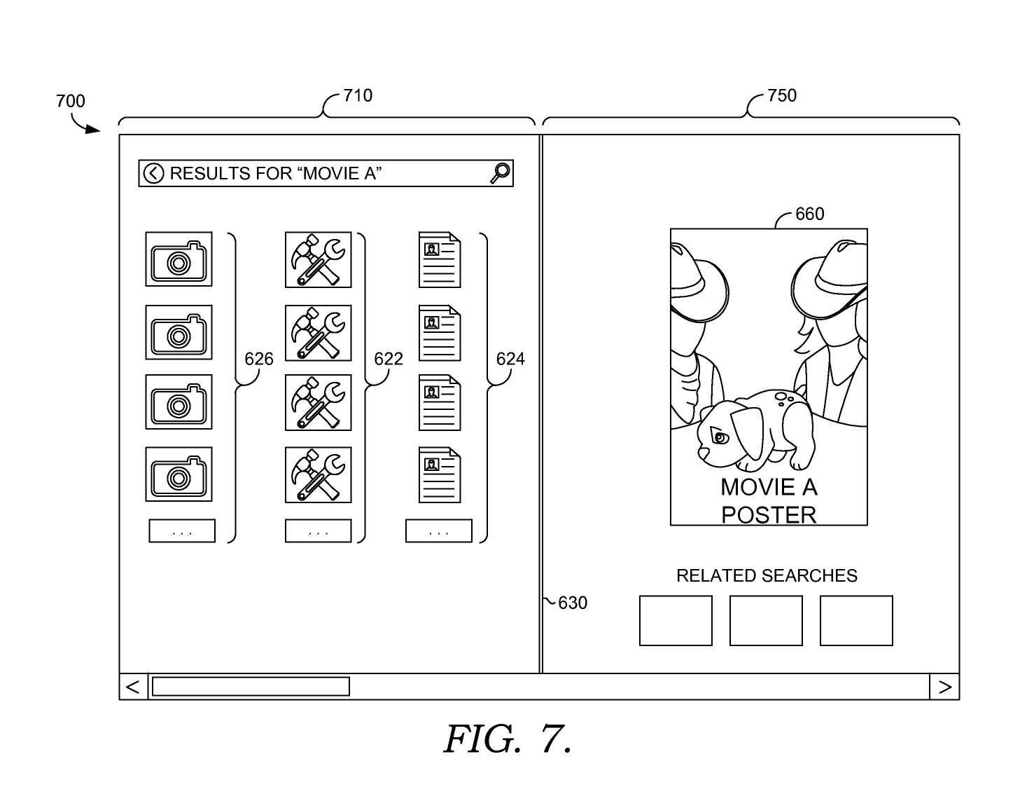

FIGS. 7-11 depict screen shots, similar to FIG. 6, after adjusting presentation characteristics based on a user's query intent using client-computed result group scores and a server-provided machine learned algorithm. A user viewing a conventional SERP display, such as SERP display 600, would need to search through a plurality of statically-sized, statically-oriented result groups to located desired content. As described above, the computed result group scores may be used to rank result groups based on how they match a user's query intent. Thus, presentation characteristics of a conventional SERP display (e.g. SERP display 600 of FIG. 6) may be adjusted to emphasize at least one result group over another based on a user's query intent. FIGS. 7-11 illustrate several embodiments of screen shots with adjusted presentation characteristics in accordance with the invention. These embodiments are only provided to assist a person having ordinary skill in the art implement the invention, and are not intended to suggest any limitation as to the scope of use or functionality of the invention. Furthermore, the illustrated screen shots should not be interpreted as having any dependency or requirement relating to any one or combination of components/modules illustrated.

FIG. 7 is an embodiment of a screen shot similar to FIG. 6 showing an exemplary SERP display area 700 after adjusting result group order based on a user's query intent. After a client device computes their respective result group scores, result groups may be ranked from highest result group score to lowest. In this example, photo result group 626 may have the highest result group score, and accordingly be placed on the far right of client domain 710. Settings result group 622 with the next highest result group score is placed in the middle of client domain 710. Documents result group 624 with a lower result group score is placed on the far right of client domain 710. Thus, the client domain 710 result group that is most relevant to the FIG. 5 user's query intent could be found on the far left of client domain 710 for emphasis. In another embodiment, a plurality of web result groups (not shown) may also be ranked from highest result group score to lowest, and reordered within web domain 750 accordingly.

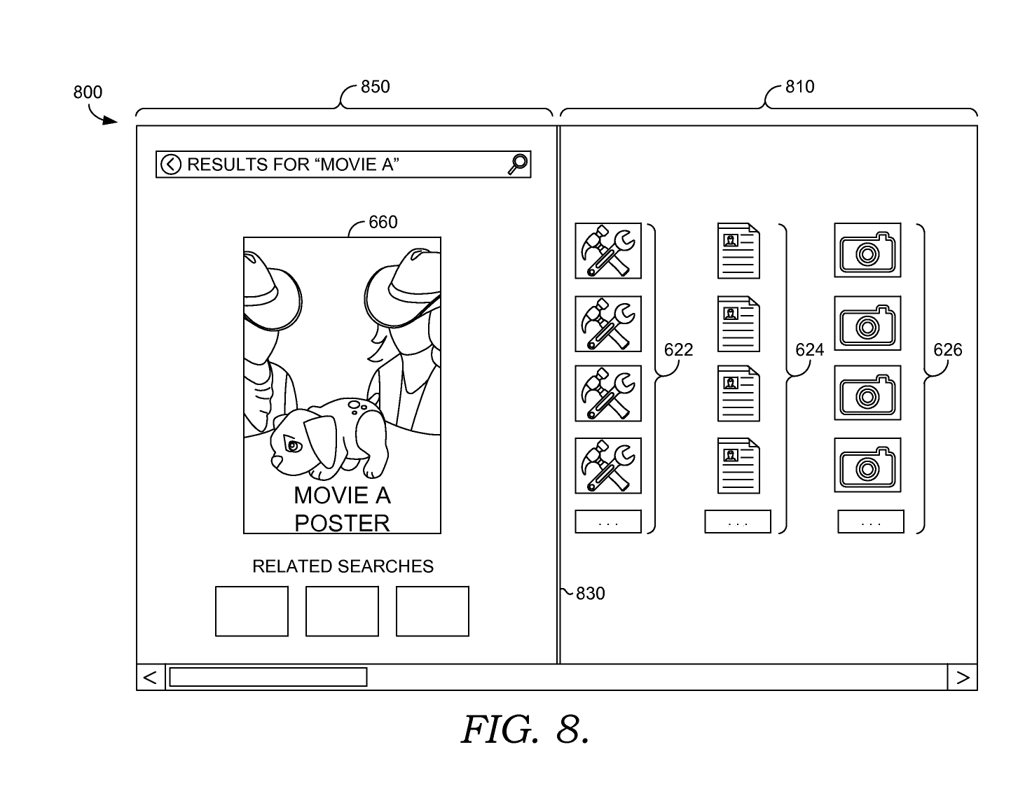

FIG. 8 is an embodiment of a screen shot similar to FIG. 6 showing an exemplary SERP display 800 after adjusting domain order based on a user's query intent. As shown in the embodiment of FIG. 8, the result domain (e.g. client domain 810 or web domain 850) may also be reordered using the result group scores for their respective result groups. For example, after computing result group scores, a cumulative domain score may be calculated using the result group scores within each respective domain. In this example, web domain 850 may be ranked higher than client domain 810 based on their respective cumulative domain scores. Accordingly, web domain 850 may be reordered with respect to client domain 810, and placed to the left of demarcation line 830 with client domain 810 being placed to the right. A demarcation line may represent a logical division of a SERP display in some embodiments that may not be viewable in some embodiments. In other embodiments, the demarcation line may be a viewable division of a SERP display. Thus, the domain comprising result groups that are most relevant to the FIG. 5 user's query intent would be located on the left of SERP display 800 for emphasis. In another embodiment, the result groups within each respective domain could also be ranked from highest result group score to lowest, and reordered within their domain accordingly.

In yet another embodiment, result groups from all domains may be interleaved and thus reordered based on ranking from highest result group score to lowest regardless of the domain. For example, in this embodiment, document result group 624 may have a higher computed result group score than a first web result group (not shown), which in turn has a higher computed result group score than photo result group 626. In this example, the result groups could be reordered such that document result group 624 is placed to the far left of SERP display 800, followed by the first web result group, followed next by photo result group 626.

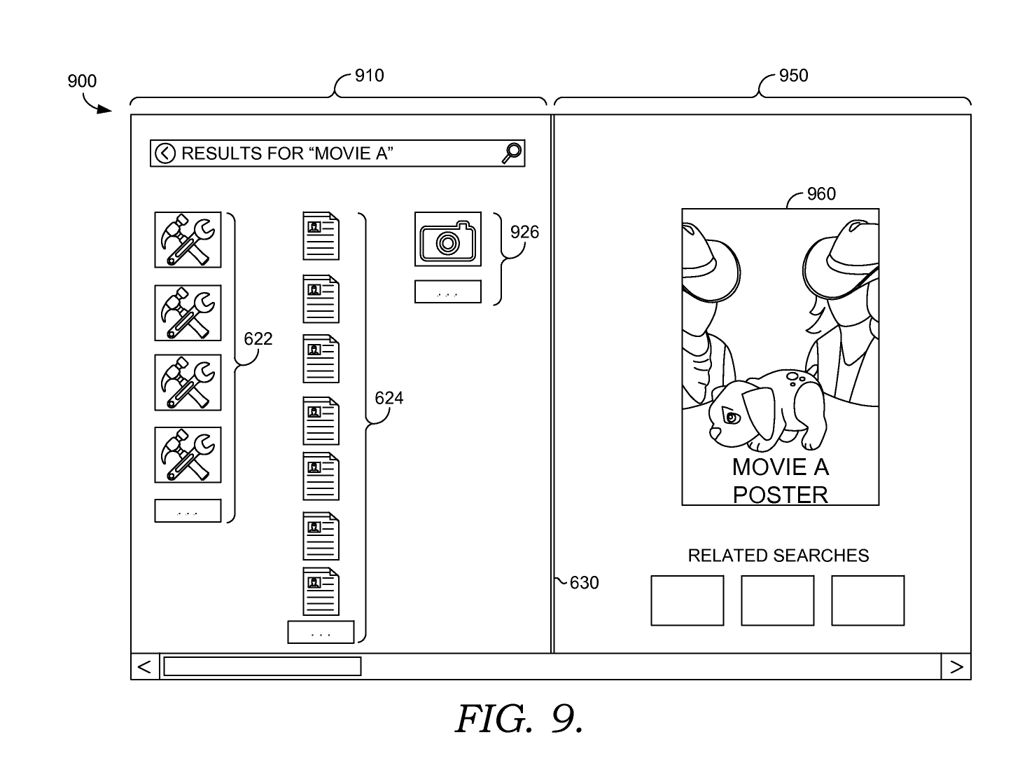

FIG. 9 is an embodiment of a screen shot similar to FIG. 6 showing an exemplary SERP display 900 after adjusting result group sizing based on a user's query intent. After computing respective result group scores, the result groups in the local domain 910 may be resized according to their result group score relative to the result group score of web result group 960 in the web domain 950 and a size threshold score.

In the embodiment shown in FIG. 9, document result group 924 may have a higher result group score than that of web result group 960. Setting result group 922 may have a lower result group score than that of web result group 960, but a higher than the size threshold score. Photo result group 926 may have a lower result group score than that of web result group 960 and the size threshold score. Accordingly, document result group 924 may be resized to a large size, setting result group 922 may remain a medium size, and photo result group 926 may be resized to a small size.

In an embodiment, a result group may be displayed by default as a medium size by displaying a default number of results from the result group in the column layout of the result group. For example, a column layout of a result group may be capable of displaying seven results of the result group. In this example, a result group may be displayed as a medium size by displaying four results in the column layout of the result group. A result group may be resized to a large size by displaying additional results from the result group in the column layout of the result group (e.g. seven results). A result group may be resized to a small size by displaying fewer results from the result group in the column layout of the result group (e.g. one result). Accordingly, in the embodiment of FIG. 9, document result group 924 has been resized to the large size by displaying seven results in a column layout. Setting result group 922 remains a medium size by displaying four results in a column layout. Photo result group 926 has been resized to the small size by displaying one result in a column layout. Thus, the client domain 910 result group that is most relevant to the FIG. 5 user's query intent could be found by locating the result groups that have been resized to a large size for emphasis. In another embodiment, a plurality of web result groups (not shown) may also be ranked from highest result group score to lowest, and resized within web domain 950 accordingly.

In another embodiment, a result group may be displayed by default as a medium size by displaying icons for the results of the result group as medium sized icons (e.g. 32×32 pixels). A result group may be resized to a large size by displaying icons for the results of the result group as large sized icons (e.g. 64×64 pixels). A result group may be resized to a small size by displaying icons for the result of the result group as small sized icons (e.g. 16×16 pixels). In this embodiment, emphasis could be placed on result groups by displaying icons for results of the result group sized accordingly in a column layout without changing the number of results displayed. Additionally, emphasis could be placed on result groups by both sizing the icons for results accordingly and changing the number of results displayed. In another embodiment, result groups with a computed result group score below a minimum value could be deemphasized by not displaying the result group on the SERP display at all. In another embodiment, result groups could be emphasized by adding an overlay to icons representing results of the result group and/or resizing the overlays added to the icons.

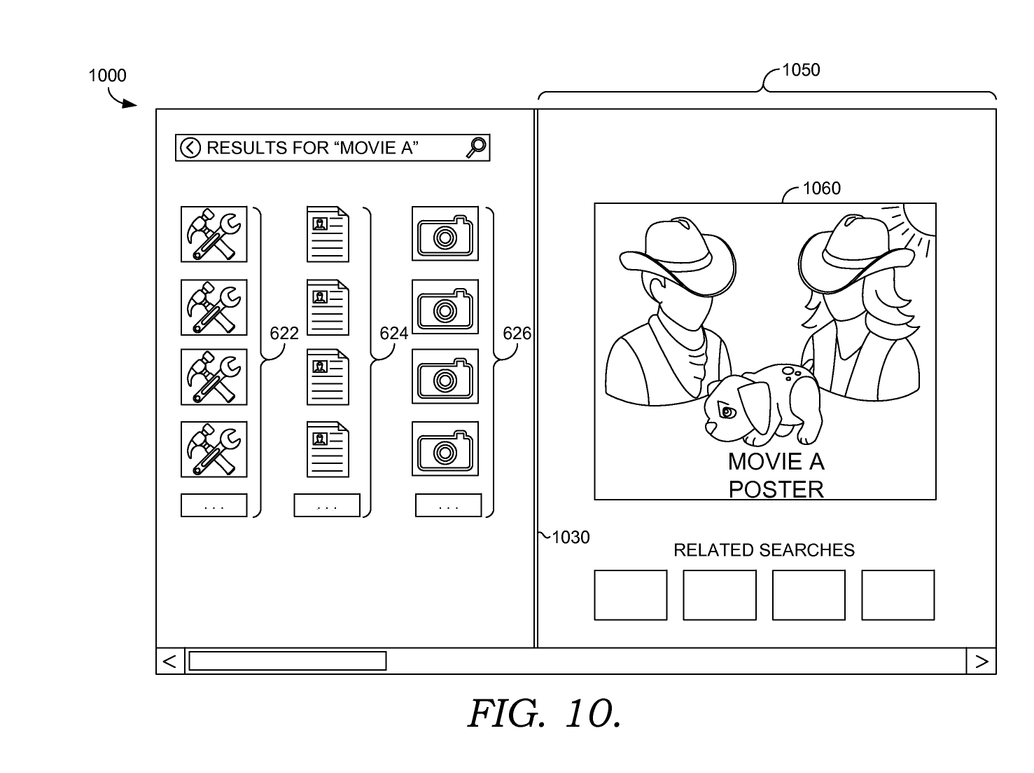

FIG. 10 is an embodiment of a screen shot similar to FIG. 6 showing an exemplary SERP display 1000 after adjusting domain sizing based on a user's query intent. As shown in the embodiment of FIG. 10, the result domains may also be resized using the result group scores for their respective result groups. For example, after computing result group scores, a cumulative domain score may be calculated using the result group scores within each respective domain. In this example, web domain 1050 may be ranked higher than client domain 1010 based on their respective cumulative domain scores. Accordingly, web domain 1050 may be resized with respect to client domain 1010 by adjusting demarcation line 1030 to apportion a larger area of SERP display 1000 to web domain 1050. In an embodiment, at least one web result group 1060 may expand to occupy a portion of the larger area of SERP display 1000 allocated to web domain 1050. Thus, the domain comprising result groups that are most relevant to the FIG. 5 user's query intent could be resized to occupy a larger area of SERP display 1000 for emphasis.

In another embodiment, the result group(s) within the domain having the highest cumulative domain score could be resized (not shown) in lieu of apportioning a larger area of the SERP display to the domain. Alternatively, the result group(s) within the domain having the highest cumulative domain score could be resized (not shown) in addition to apportioning a larger area of the SERP display to the domain. In yet another embodiment, each respective result group could be resized based on ranking from highest result group score to lowest regardless of the domain. In this embodiment, resizing the result groups could occur with or without apportioning a larger area of the SERP display to their respective domains.

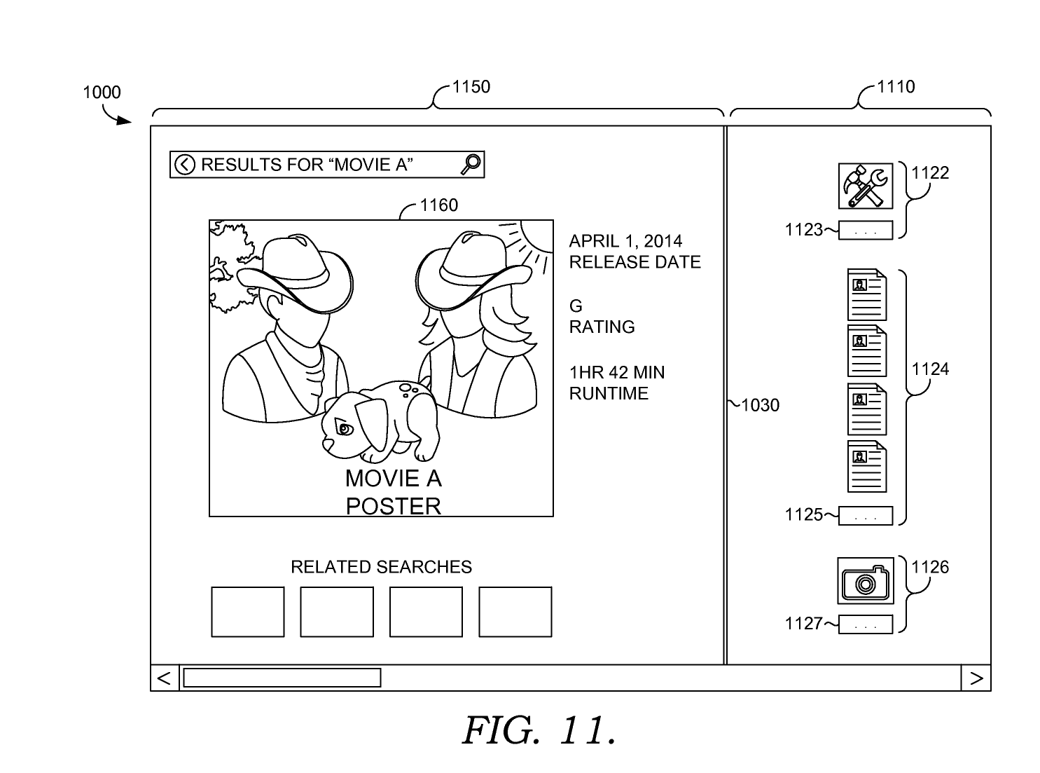

FIG. 11 is an embodiment of a screen shot similar to FIG. 5 showing an exemplary SERP display 1100 after adjusting result group order and sizing based on a user's query intent. As shown in the embodiment of FIG. 11, the result domains may also be resized and their respective result groups reordered using the result group scores for their respective result groups. For example, after computing result group scores, a cumulative domain score may be calculated using the result group scores within each respective domain. In this example, domains may be ranked based on their respective cumulative domain scores. Accordingly, higher ranked domain domains may be resized by adjusting demarcation line 1130 to apportion them a larger area of SERP display 1100.

In the embodiment shown in FIG. 11, a client device may calculate that web domain 1150 has a higher cumulative domain score than client domain 1110. Accordingly, web domain 1150 may be resized by adjusting demarcation line 1130 to apportion a larger area of SERP display 1100 with respect to client domain 1110 to web domain 1150. In an embodiment, client domain 1110 and web domain 1150 may also be reordered with respect to demarcation line 1130 such that web domain 1150 is placed to the left of demarcation line 1130. Document result group 1124 may have a lower result group score than that of web result group 1160, but a higher than the size threshold score. Both setting result group 1122 and photo result group 1126 may have a lower result group score than that of web result group 1160 as well as the size threshold score. Accordingly, document result group 1124 may be remain a medium size while setting result group 1122 and photo result group 1126 may both be resized to a small size. Also, in this embodiment, all of the result groups in client domain 1110 may be reordered to form a single column. This may be used minimize the emphasis on client domain 1110 when the client device determines that the result groups of web domain 1150 are notably more relevant to a user's query intent based on the computed result group scores.

In an embodiment, all results within a results group may still be available to the user even when not displayed on a SERP display. In this embodiment, “more results” indicators 1123, 1125, and 1127 can be displayed to provide an indication to a user that one or more additional results can be displayed upon selection. More result indicators can be represented in any manner, such as a text link, an arrow-shaped link, etc. Such indicators can provide a user an avenue for interacting with results not initially displayed.

As shown above in the embodiments of FIGS. 7-11, the presentation characteristics of a SERP display may be adjusted in any number of ways to emphasize at least one result group and/or domain over another. These presentation characteristic adjustments may be based on client device computations using machine learned algorithms provided by a remote server. For example, presentation characteristics such as color, fonts, highlights, framing elements, shading, underlining, italicizing, and the like may be adjusted to place emphasis on at least one result group over another.

In some embodiments, machine learned algorithms provided by a remote server may be used by a client device to compute a variety of values regarding each result group and result. In these embodiments, at least one presentation characteristic may be adjusted based on a client device calculated value that is not a result group or cumulative domain score using the machine learned algorithms.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the figures and described above are not meant to limit the scope of the embodiments of the invention in any way and, in fact, the steps may occur in a variety of different sequences within embodiments hereof. Any and all such variations, and any combination thereof, are contemplated to be within the scope of embodiments of the invention.

What is claimed is:

1. One or more computer-readable media having computer-executable instructions thereon that when executed by a computing device perform a method of adjusting presentation characteristics of a search engine results page (SERP) based on a query intent of a user, the method comprising:
transmitting a search prefix comprising at least one character associated with an unexecuted search query to a search service;
receiving one or more query suggestions and a machine learning algorithm configured to each query suggestion in response to the search prefix;
transmitting an executed search query selected by the user from the query suggestions based in part on the query intent to a local search component configured to locate content stored in a local domain;
receiving a plurality of result groups comprising at least one search result identifying content in the local domain from the local search component, wherein the local search component ranks search results within each result group based on a relevance to the executed search query; and
computing a result group score defining a relevance of the result group to the query intent for each of the plurality of result groups using the machine learning algorithm configured to the selected query suggestion.

2. The media of claim 1, wherein the method further comprises presenting the plurality of result groups to the user on the SERP, wherein at least one of the result groups is emphasized over another result group based on their respective result group scores.

3. The media of claim 2, wherein at least one of the result groups is emphasized over another result group through a result group layout order on the SERP based on their respective result group scores.

4. The media of claim 2, wherein at least one of the result groups is emphasized over another result group by adjusting a result group layout size on the SERP for each result group based on their respective result group scores.

5. The media of claim 2, wherein at least one of the result groups is emphasized over another result group by adjusting a result group presentation characteristic for at least one of the result groups based on the result group score.

6. The media of claim 2, wherein the method further comprises:
transmitting the executed search query to a remote search component configured to locate content stored in a web domain available to the user via a network communicatively coupled to the computing device;
receiving at least one result group comprising at least one search result identifying content in the web domain from the remote search component, wherein the remote search component ranks search results within each result group based on a relevance to the executed search query; and
presenting the result groups from both the local domain and the web domain to the user on the SERP.

7. The media of claim 6, wherein the method further comprises computing a domain score based on the result groups within the domain for the local domain and the web domain, wherein one domain is emphasized over the other based on their respective domain scores.

8. The media of claim 7, wherein one domain is emphasized over the other by adjusting a domain layout order on the SERP based on their respective domain scores.

9. The media of claim 7, wherein one domain is emphasized over the other by adjusting a domain layout size on the SERP based on their respective domain scores.

10. The media of claim 6, wherein result groups from the local domain and web domain are presented in an interleaved layout order on the SERP, and wherein at least one result group is emphasized over another based on their respective result group score without regard to the domain of the result group.

11. The media of claim 1, wherein the method further comprises transmitting an updated search prefix to the search service prior to transmitting the executed search query.

12. The media of claim 11, wherein the method further comprises receiving one or more updated query suggestions and a machine learning algorithm configured to each updated query completion suggestion.

13. One or more computer-readable media having computer-executable instructions thereon that when executed by a computing device perform a method of adjusting presentation characteristics of a search engine results page (SERP) based on a query intent of a user, the method comprising:
receiving a search prefix comprising at least one character associated with an unexecuted search query from a client device; and
transmitting one or more query suggestions and one or more machine learning algorithms configured to each query suggestion in response to the search prefix, each machine learning algorithm configured to compute a result group score defining a relevance of a result group associated therewith to the query intent upon execution thereof, the execution being triggered upon receipt of a user-selection of the respective query suggestion.

14. The media of claim 13, wherein at least a portion of the result groups are presented to the user on the SERP, and wherein at least one of the result groups is emphasized over another result group based on their respective result group scores.

15. The media of claim 14, wherein the method further comprises:
receiving the search query; and
transmitting at least one result group comprising at least one search result identifying content stored in a web domain to a client device in response to the search query, wherein the content stored in the web domain is available to the user via a network communicatively coupled to the client device.

16. The media of claim 13, wherein the method further comprises:
receiving at least one result group score from a client device; and
storing the result group score to a query log database comprising a plurality of result group scores each associated with a previous search query.

17. The media of claim 16, wherein the method further comprises training the machine learning algorithm using the query log database.

18. The media of claim 16, wherein the method further comprises tailoring a future query suggestion and one or more machine learning algorithms configured to the future query suggestion in response to a future search prefix from the user based on result group scores received from the user.

19. One or more computer-readable media having computer-executable instructions thereon that when executed by a computing device perform a method of adjusting presentation characteristics of a search engine results page (SERP) based on a query intent of a user, the method comprising:
transmitting a search prefix comprising at least one character associated with an unexecuted search query to a search service;
receiving one or more query suggestions and a machine learning algorithm configured to each query suggestion in response to the search prefix;
transmitting an executed search query selected by the user from the query suggestions based in part on the query intent to a local search component configured to locate content stored in a local domain and a remote search component configured to locate content stored in a web domain available to the user via a network communicatively coupled to the computing device;
receiving a plurality of result groups comprising at least one search result identifying content in the local domain from the local search component, wherein the local search component ranks search results within each result group based on a relevance to the executed search query;
computing a result group score defining a relevance of the result group to the query intent for each of the plurality of result groups using the machine learning algorithm configured to the selected query suggestion prior to receiving search results from the remote search component; and
presenting the plurality of result groups from the local search component to the user on the SERP, wherein at least one of the result groups are emphasized over another result group based on their respective result group scores.

20. The media of claim 19, further comprising:
receiving at least one result group comprising at least one search result from the remote search component; and
presenting result groups from the remote search component to the user on the SERP without re-computing result group scores.
